(19) United States
(12) Patent Application Publication
(10) Pub. No.: US 2017/0025095 A1
(43) Pub. Date: Jan. 26, 2017

(54) Mobile Device, Action Performing System and Action Performing Method

(71) Applicants: BOE TECHNOLOGY GROUP CO., LTD., Beijing (CN); Beijing BOE Multimedia Technology Co., Ltd., Beijing (CN)

(72) Inventors: Chunguang LV, Beijing (CN); Pei LI, Beijing (CN); Xiao SU, Beijing (CN); Zeyang FAN, Beijing (CN); Jigang LV, Beijing (CN); Jinchao TANG, Beijing (CN); Caixia GUO, Beijing (CN)

(21) Appl. No.: 15/146,970

(22) Filed: May 5, 2016

(30) Foreign Application Priority Data
Jul. 22, 2015 (CN) 201510434383.8

(51) Int. Cl. G09G 5/12; G06F 3/14; G06F 3/16; H04W 48/16

(52) U.S. Cl. CPC G09G 5/12; H04W 48/16; G06F 3/1454; G06F 3/16; G06F 3/1423; H04W 84/12

(57) ABSTRACT

A mobile device, an action performing system and an action performing method can solve the problems such as inconvenient operation and ease of misoperation occurring in practicing action transfer with present multi-screen interaction technique. The mobile device includes: an executing unit, for performing an action of displaying an image and/or playing a sound; a processing unit, for acquiring optional information, determining whether to transfer the action to a fixed device based on the optional information, and transferring the action to the fixed device if the determination result is yes, otherwise not transferring the action, the optional information including a distance between the fixed device and the mobile device; and a first wireless communication unit, for enabling the mobile device to perform a first information exchange with the fixed device in a wireless manner, the first information exchange including sending information required for performing the action to the fixed device.

### FIELD OF THE INVENTION

The present invention belongs to the field of mobile device technology, and in particular relates to a mobile device, an action performing system and an action performing method.

### BACKGROUND OF THE INVENTION

As the development of mobile device technology, mobile devices such as mobile phones, tablet PCs and the like are more and more widely applied. These mobile devices often perform actions such as displaying an image (for example, a video, a document, or a game screen), playing a sound (for example, music, video sound etc.) and the Apparently, compared to fixed devices such as TVs, computers, monitors, speakers and the like, display screen sizes, resolutions, power amplifier volumes and power amplifier sound qualities etc. of mobile devices are significantly limited, usually inferior to those of fixed devices. Thus, if an action being performed in a mobile device can be transferred to and performed in a fixed device (for example, a movie stored in a mobile phone is transferred to a TV to be played on it), then a better experience effect can be achieved. Such a process is called “action transfer”.

The action transfer can be achieved by multi-screen interaction technology in the prior art, which usually includes the following steps: connecting a mobile phone to a WiFi (Wireless Fidelity) in a home; connecting a TV in the home to the WiFi with the mobile phone accessed thereto; installing a multi-screen interaction software on the TV; opening the multi-screen interaction software on the TV to find and match the mobile phone; opening a video player in the mobile phone; and making a selection to transfer a video to the TV and play the video on it.

As can be seen, the present multi-screen interaction technique requires a user to select a fixed device (such as a TV) and carry out an operation of transferring a present action (such as playing a video) to the fixed device on his/her own. But such an operation requires professional knowledge, and it is difficult for an ordinary user who has not acquired such professional knowledge to complete the operation. Also, such operation is inconvenient, and it is often the case that the action cannot be transferred successfully due to mistakes and the like.

### SUMMARY OF THE INVENTION

The present invention provides a mobile device, an action performing system and an action performing method that can realize simple and convenient action transfer, for solving the problems such as inconvenient operation and ease of misoperation arising when performing the action transfer with the existing multi-screen interaction technique.

As a technical solution to the above problem, a mobile device comprises:

an executing unit, for performing an action of displaying an image and/or playing a sound;

a processing unit, for acquiring optional information, determining whether to transfer the action to a fixed device based on the optional information, and transferring the action to the fixed device if the determination result is yes, otherwise not transferring the action, the optional information including a distance between the fixed device and the mobile device; and

a first wireless communication unit, for enabling the mobile device to perform a first information exchange with the fixed device in a wireless manner, the first information exchange includes sending information required for performing the action to the fixed device.

Optionally, the optional information further includes at least one of a type of the action, a property of the fixed device, and a historic record of action transfer.

Optionally, the processing unit is further used for, after transferring the action to the fixed device, determining whether to transfer the action that has been transferred to the fixed device back to the mobile device based on the distance between the fixed device and the mobile device, and transferring the action that has been transferred to the fixed device back to the mobile device if the determination result is yes, otherwise not transferring the action that has been transferred to the fixed device.

Optionally, the first information exchange further includes receiving the optional information stored in the fixed device from the fixed device.

Optionally, the first wireless communication unit is a wireless local area network unit.

Optionally, the mobile device is a mobile communication terminal or a tablet PC.

As a technical solution to the above problem, an action performing system comprises:

at least one mobile device described above;

at least one fixed device capable of performing an action of displaying an image and/or playing a sound, which includes a second wireless communication unit; and

a distance measurement unit, wherein

the second wireless communication unit is used for enabling the fixed device to perform a second information exchange with the mobile device in a wireless manner, the second information exchange includes receiving information from the mobile device required for performing the action; and

the distance measurement unit is used for detecting a distance between the mobile device and the fixed device, and sending the detection result to the processing unit of the mobile device.

Optionally, the at least one fixed device includes a plurality of fixed devices;

the processing unit of the mobile device determines whether to transfer the action to the fixed device based on the optional information, specifically, compares the optional information of the plurality of fixed devices with each other, and determines whether to transfer the action to one of the plurality of fixed devices; if the determination result is yes, transfers the action to the one of the plurality of fixed devices, otherwise does not transfer the action.

Optionally, the second wireless communication unit is a wireless local area network unit.

Optionally, the second information exchange further includes sending the optional information stored in the fixed device to the mobile device.

Optionally, the fixed device includes one or more of a TV, a computer, a monitor, and a speaker.

As a technical solution to the above problem, an action performing method comprises:

performing, by a mobile device, an action of displaying an image and/or playing a sound;

acquiring, by the mobile device, optional information, the optional information including a distance between the fixed device and the mobile device;

determining, by the mobile device, whether to transfer the action to the fixed device based on the optional information; and

if the determination result is yes, then sending, by the mobile device, information required for performing the action to the fixed device in a wireless mariner, and performing the action by the fixed device, otherwise not transferring the action.

Optionally, the method further comprises:

after transferring the action to the fixed device, determining, by the mobile device, whether to transfer the action that has been transferred to the fixed device back to the mobile device based on the distance between the fixed device and the mobile device; if the determination result is yes, then stopping performing the action by the fixed device, and continuing to perform the action by the mobile device, otherwise not transferring the action that has been transferred to the fixed device.

The mobile device of the present invention has a processing unit, which can determine whether to transfer a present action to a fixed device based on the distance between the mobile device and the fixed device, thus the mobile device can automatically transfer the present action to the fixed device when it is close to the fixed device, to obtain a better experience effect, without the need for a user to perform transferring operation on his/her own, thereby realizing simple operation, less mistakes, and ease of implementation.

### BRIEF DESCRIPTION OF THE DRAWINGS

FIG. 1 is a schematic block diagram of a structure of an action performing system in Embodiment 2 of the invention.

FIG. 2 is a schematic diagram of the status of each stage of an action performing method in Embodiment 3 of the invention.

### DETAILED DESCRIPTION OF THE EMBODIMENTS

In order to provide a better understanding of the technical solutions of the present invention to the skilled in the art, the invention is described below in further detail in conjunction with the drawings and specific implementations.

### Embodiment 1

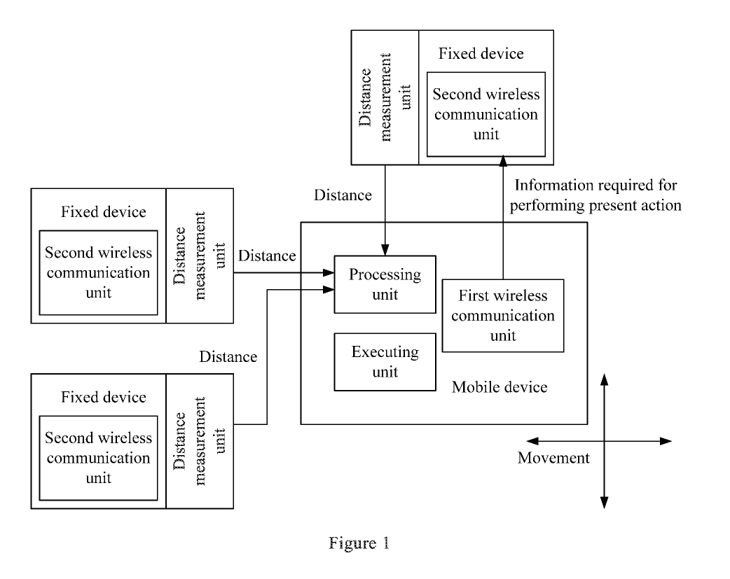

This embodiment provides a mobile device, which includes an executing unit, a processing unit and a first wireless communication unit (see the mobile device in FIG. 1).

In this embodiment, the executing unit is used for performing an action of displaying an image and/or playing a sound.

The mobile device of this embodiment refers to an electronic device that can be carried around by a user, with a function of displaying images and/or playing sounds. For example, the mobile device may be used for watching movies, reading e-books, playing games, listening to music and the like. The executing unit may be a display screen, power amplifier and the like.

Optionally, the mobile device may be a mobile communication terminal (e.g. a mobile phone etc.) or a tablet PC (e.g. an iPad etc.), which are currently the most commonly used types of mobile devices. Of course, it may also be other types of mobile devices.

The processing unit is used for acquiring optional information, determining whether to transfer the present action being performed by the executing unit to a fixed device based on the optional information, and transferring the present action to the fixed device if the determination result is yes, otherwise not transferring the present action. The optional information may be information on the fixed device, which includes a distance between the fixed device and the mobile device, and the like.

The processing unit of the mobile device of this embodiment may acquire optional information of a fixed device (including at least a distance between the fixed device and the mobile device), determine whether to transfer the action presently being performed to the fixed device according to the optional information, and transfer the present action to the fixed device if the determination result is yes, otherwise not transferring the present action. Apparently, when a user moves around in a home carrying the mobile device, distances between the mobile device and fixed devices in the home are constantly changing. When a distance between the mobile device and a fixed device meets a certain requirement (e.g. less than 5 meters), the mobile device may then transfer the action being performed by it to the fixed device.

The processing unit of the mobile device of this embodiment may determine whether to transfer the present action to a fixed device according to the distance between the mobile device and the fixed device, thus the mobile device may automatically transfer the present action to the fixed device when it is close to the fixed device, to obtain a better experience effect, without the need or a user to perform transferring operation on his/her own, thereby avoiding problems such as inconvenient operation, ease of misoperations and so on.

Optionally, the optional information includes at least one of a type of the present action, a property of a fixed device, and a historic record of action transfer.

In other words, the processing unit may also determine or comprehensively determine whether to transfer the present action based on other optional information instead of or in addition to the distance between the fixed device and the mobile device.

Herein, the “type of the present action” includes what action there is being performed presently, what requirements the action has, and the like, which determines which fixed devices the present action can be transferred to. For example, if an action of reading an e-book is being performed presently, then a target fixed device is only required to have a function of displaying images, and it is not required to have a function of playing sounds; and if an action of watching a movie is being performed presently, then a target fixed device is required to be able not only to display images but also to play sounds.

The “property of a fixed device” includes a type, a model, hardware status, software information and the like of a fixed device, specifically, such as a size of a display screen of a fixed device, if a fixed device has a touch control function or not, a processor model of a fixed device, and so on. This information determines which actions a fixed device is suited for. For example, a size of a TV is usually bigger than that of a monitor, so it is more suited for playing videos than a monitor; and a speaker only has a function of playing sounds, so it can be only used for playing music and the like, and cannot be used for reading e-books and the like.

The “historic record of action transfer” refers to a record of action transfer cases that have been previously happened, which includes what actions were transferred to what fixed devices in what cases. The processing unit may determine whether to perform action transfer based on the historic record.

Optionally, the processing unit is further used for, after transferring the present action to a fixed device, determining whether to transfer the present action that is being performed by the fixed device back to the mobile device based on the distance between the fixed device and the mobile device, and transferring the present action that is being performed by the fixed device back to the mobile device if the determination result is yes, otherwise not transferring the present action that is being performed by the fixed device.

Apparently, after the present action is transferred to a fixed device, the user may move to a place far from the fixed device while carrying the mobile device (for example, leaving the room where a TV is placed), and now it is not appropriate to continue performing the present action in the fixed device, therefore the processing unit may transfer the present action back to the mobile device upon discovering that the distance between the fixed device and the mobile device is too far, thereby continue performing the present action in the mobile device.

The first wireless communication unit is used for enabling the mobile device to perform an information exchange with the fixed device in a wireless manner. The information exchange includes sending information required for performing the present action to the fixed device, and also includes receiving optional information stored in the fixed device from the fixed device.

Apparently, because the present action was originally performed in the mobile device, relative information thereof is all stored in the mobile device (for example, a video file is stored in a phone), thus in order to perform the action in the fixed device, information required for performing the action (for example, video play progress, bit stream etc.) must be sent from the mobile device to the fixed device, which is done by the first wireless communication unit.

Optionally, the first wireless communication unit may be a wireless local area network unit (WLAN unit), specifically a WiFi unit. A wireless local area network unit is selected because the transmission is usually stable and fast without generating a network flow fee; moreover, fixed devices are generally provided in fixed sites such as homes, and it is convenient to connect them to a wireless local area network. Of course, public wireless network (such as 3G network, 4G network etc.) unit, Bluetooth unit, infra-red communication unit and the like may also be employed as the first wireless communication unit.

Furthermore, as previously described, the processing unit need to acquire the optional information, and some of the optional information (such as properties of a fixed device, etc.) may be stored in a fixed device, thus such optional information stored in a fixed device may also be delivered via the first wireless communication unit.

### Embodiment 2

As shown in FIG. 1, this embodiment provides an action performing system capable of realizing action transfer, which includes:

at least one mobile device described above;

at least one fixed device capable of performing an action of displaying an image and/or playing a sound, which includes a second wireless communication unit; and

a distance measurement unit.

The second wireless communication unit is used for enabling the fixed device to perform an information exchange with the mobile device in a wireless manner, the information exchange includes receiving information from the mobile device required for performing the action, and also includes sending optional information stored in the fixed device to the mobile device.

The distance measurement unit is used for detecting a distance between the mobile device and the fixed device, and sending the detection result to the processing unit of the mobile device.

In other words, this embodiment provides an action performing system, which includes at least one mobile device described above, and one or more fixed devices, so that when a user comes close to these fixed devices while carrying the mobile device, a present action of the mobile device can be automatically transferred to an appropriate fixed device so as to be performed. When the above mobile device is more than one, each mobile device can perform action transfer separately, without affecting one another. Thus hereinafter, operation of the action performing system of this embodiment is described taking an action performing system including only one mobile device described above as an example.

A mobile device may be a mobile communication terminal, a tablet PC and the like; and a fixed device usually refers to a device provided at a fixed position, with a capability of performing an action of displaying images and/or playing sounds. Optionally, the fixed device may include one or more of a TV, a computer, a monitor, and a speaker.

To realize an information exchange with the first wireless communication unit in the mobile device, a corresponding second wireless communication unit should be provided in each fixed device. The second wireless communication unit is used at least for receiving information required for performing the present action from the first wireless communication unit, and may also send the optional information such as properties of a fixed device to the first wireless communication unit. Optionally, the second wireless communication unit may also be a wireless local area network unit (e.g. WiFi unit).

Optionally, there may be a plurality of fixed devices; the processing unit of the mobile device determines whether to transfer the present action to a fixed device according to the optional information, specifically, it may compare the optional information of the plurality of fixed devices with each other, and determine to transfer the present action to one of the plurality of fixed devices, or not to transfer the present action.

In other words, when there are a plurality of fixed devices (for example, multiple fixed devices provided in a user's home), the mobile device (for example, the user's mobile phone) may discover there are a plurality of fixed devices nearby at the same time (of course, distances between the fixed devices and the mobile device may be different), but at the moment the present action needs to be transferred to only one of the fixed devices. Thus, the processing unit of the mobile device needs to compare the optional information of the fixed devices, and determine which fixed device the present action should be transferred to, or not to transfer the present action.

Specifically, the processing unit of the mobile device determines based on the above optional information, i.e. at least based on the distances between the mobile device and the fixed devices, so that the fixed device with the smallest distance may be selected for the transfer of the present action.

Of course, when more other information is also included in the optional information (such as a type of the present action, properties of a fixed devices, historic records of action transfer and the like), the processing unit may also determine or comprehensively determine which fixed device the present action should be transferred to based on these option al information.

For example, as a specific way of determination, the processing unit of the mobile device may give a score for each fixed device according to the distance between the fixed device and the mobile device, the degree of suitability of the fixed device for the present action (obtained by the type of the present action, and properties of the fixed device), the historic record of action transfer and the like, and transfer the present action to the fixed device with the highest score. Specifically, when the mobile device is performing the action of reading an e-book, assume that it is relatively far from a TV and relatively close to a monitor, but at the same time the screen of the TV is bigger than that of the monitor, which makes the TV more suitable for performing the action of reading an e-book. The processing unit needs to comprehensively determine which fixed device is more suitable (has higher score) according to the difference between the distance from the mobile device to the TV and the distance from the mobile device to the monitor, and the difference between the size of the screen of the TV and the size of the screen of the monitor, and determine to transfer the action of reading an e-book to the more suitable fixed device (with higher score).

For another example, as another specific way of determination, different priorities may be set for the above optional information, and the determination is made according to the type of optional information with the highest priority. When the determination cannot be made according to the optional information with a higher priority, it can be made according to the optional information with a lower priority. Specifically, the determination may be made firstly according to the distance between the fixed device and the mobile device, and when two or more fixed devices are at similar distances from the mobile device, the determination regarding to which fixed device the present action should be transferred to can be made based on the historic record of action transfer.

In conclusion, any criteria for the determination is acceptable as long as one can determine which fixed device the present action should be transferred to based on the optional information (including at least the distance between the fixed device and the mobile device). The specific criteria for the determination may be set beforehand, or may be set temporarily by a user based on his/her own needs. Because various specific methods, criteria and the like for the determination are known, detailed descriptions thereof are omitted here.

After the present action of the mobile device is transferred to a fixed device, the user may move around while carrying the mobile device, so the fixed device most suitable for performing the present action at the moment may change. At this time the mobile device may transfer the present action back from the above fixed device first, and then again transfer the present action to an appropriate fixed device for continuing performing the present action. It is to be noted that above transfer process should not be construed as the present action being transferred between fixed devices.

Apparently, the distance between the mobile device and the fixed device is constantly changing as the mobile device moves, so a distance measurement unit is needed to measure the distance between the mobile device and the fixed device and send the measurement result to the processing unit of the mobile device.

Specifically, the distance measurement unit may be a device in a known form, such as an infra-red distance measurement unit, which will not be described in detail here.

The distance measurement unit can be provided at various positions. For example, as shown in FIG. 1, each fixed device may be provided with a distance measurement unit for detecting at any time the distance from the mobile device, and sending the detection result to the processing unit of the mobile device (for example, through the second wireless communication unit). Or, the distance measurement unit may be provided on the mobile device, detecting the respective distance from each fixed device, and sending the detection result to the processing unit of the mobile device. Or, the distance measurement unit may be provided alone, detecting the positions of the mobile device and the fixed device, to calculate the distance between the mobile device and the fixed device and sent the result to the processing unit of the mobile device. In conclusion, it does not matter where the distance measurement unit is provided, as long as the distance measurement unit can detect the distance between the mobile device and the fixed device, and send the detection result to the processing unit of the mobile device.

The action performing system of this embodiment comprises the fixed device(s) and the mobile device, in which the fixed device(s) may be provided within a particular space, which may be an indoor space such as a home, an office, or a studio, or an outdoor space. When a user enters the above space while carrying a mobile device (e.g. a mobile phone) and moves around in the space, the mobile device may acquire at any time the distance from each fixed device, and automatically transfer a present action to a suitable fixed device at an appropriate time, to obtain a better effect of experience. This transfer process is automatic, without the need for the user to operate on his/her own, to realize convenience and reduce misoperations.

Of course, the “automatic” transfer here does not indicate that a user cannot intervene in the transfer process. For example, the user can make a private setting beforehand, so that the present action will not be transferred when the private setting is on. For another example, before an action transfer happens, a question window may pop up on the mobile device to wait for user's confirmation, and the action transfer is performed after the user has confirmed.

### Embodiment 3

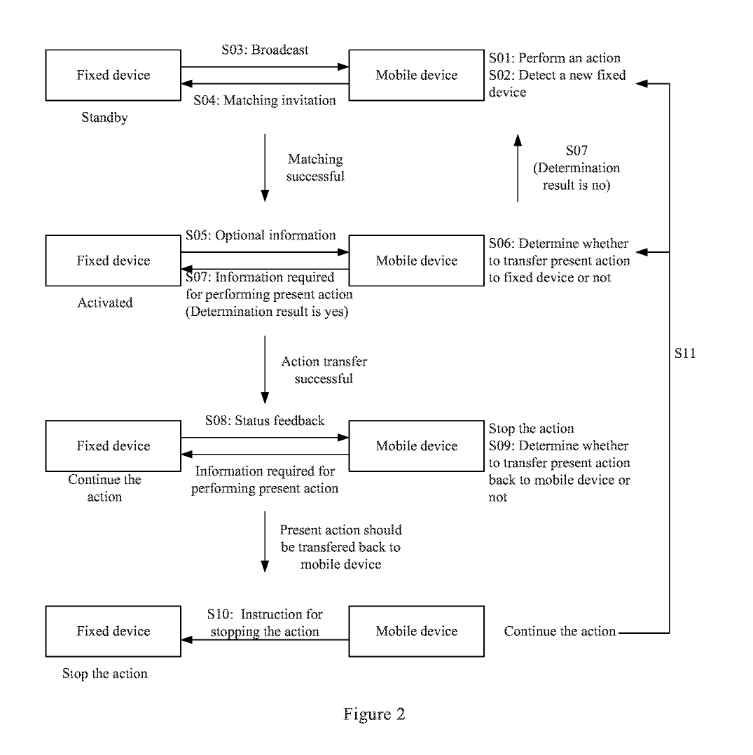

As shown in FIG. 2, this embodiment provides an action performing method, which comprises the following steps.

Step S01: performing, by a mobile device, an action of displaying an image and/or playing a sound.

In other words, the mobile device is performing an action such as playing videos, playing games, playing music and so on.

Step S02: optionally, if the mobile device has accessed to a wireless network, automatically entering the state of detecting a new fixed device.

In other words, when the mobile device is performing the above action and accessed to a wireless network such as a WiFi (for example, a user comes back home), it starts to prepare for receiving information from a fixed device accessed to the same wireless network.

Step S03: optionally, sending, by each fixed device accessed to the same wireless network, a broadcast to the mobile device.

In other words, when a mobile device appears in the scope of the wireless network, each fixed device in the wireless network starts to send out broadcast information for matching with the mobile device.

Step S04: optionally, if the mobile device has received a broadcast of a fixed device, sending a matching invitation to the fixed device; and after the fixed device accepts the matching invitation, finishing the matching with the fixed device.

In other words, after the mobile device receives a broadcast from a fixed device, it sends out matching invitation to the fixed device selectively. And after the fixed device accepts the matching invitation, a connection to the fixed device is established. If the fixed device rejects the matching invitation due to some reason (for example, being used by another user), then the mobile device returns to Step S02, to detect a new fixed device again.

Above matching process is for the mobile device to select a desired fixed device to transfer an action. This is because sometimes the mobile device may come close to an fixed device undesired to transfer an action, for example, a user carrying a mobile device enters a friend's home, in this case the user may not desire to transfer actions between his/her own mobile device and a fixed device in the friend's home.

Of course, above matching process is not essential, and may be implemented in various ways, for example, it may be required that the matching of a mobile device and a fixed device is completed only after a user inputs a password.

Step S05: acquiring, by the mobile device, optional information, wherein the optional information may be information on the fixed device, which includes information such as a distance between the fixed device and the mobile device.

In other words, after finishing the matching between the fixed device and the mobile device, a connection to the mobile device can be established via above first wireless communication unit and second wireless communication unit, then the optional information such as a distance between the fixed device and the mobile device, properties of the fixed device, and the like may be sent to the mobile device.

Step S06: determining, by the mobile device, whether to transfer a present action to the fixed device based on the optional information.

In other words, the processing unit of the mobile device determines whether to transfer the present action to the fixed device according to the optional information. When the fixed device is more than one, this step includes: comparing the optional information of the fixed devices with each other, and determining which fixed device the present action should be transferred to, or not to transfer the present action.

Step S07: if it is determined that the present action should be transferred to a fixed device, then sending information required for performing the present action to the fixed device in a wireless manner, stopping performing the present action by the mobile device, and continuing performing the present action by the fixed device; otherwise, not transferring the present action, or returning to Step S02 to detect a new fixed device again.

In other words, if the determination result of the mobile device is to transfer the present action to a fixed device, then the information required for performing the action is sent to the fixed device via the first wireless communication unit and the second wireless communication unit successively. Then the fixed device starts to perform the present action, thereby completing the action transfer. Taking a case where the present action is playing a video as an example, the information required for performing the present action includes video address, bit stream, play progress and the like.

Step S08: optionally, sending, by the fixed device, a status feedback to the mobile device.

In other words, after the fixed device starts to perform the present action, it sends a feedback to the mobile device, to confirm that the present action is successfully transferred, and continues performing the present action at the same time. Of course, the mobile device needs to continue providing the information required for performing the present action to the fixed device.

Step S09: determining, by the mobile device, whether to transfer the present action back to the mobile device based on the distance between the fixed device and the mobile device.

In other words, after transferring the present action to the fixed device, the user may move around while carrying the mobile device, increasing the distance between the mobile device and the fixed device, thereby making the fixed device no longer suitable for performing the present action. Thus it is necessary at this time to determine whether the distance between the mobile device and the fixed device is too long, and decide whether to transfer the present action back to the mobile device.

Step S10: if it is determined that the present action should be transferred back to the mobile device, then stopping, by the fixed device, performing the present action, and continuing, by the mobile device, performing the present action; otherwise not transferring the present action.

In other words, when the distance between the mobile device and the fixed device is too long, it is determined that the present action should be transferred back to the mobile device. In this case, the mobile device then sends an instruction for stopping the present action to the fixed device, and the fixed device stops performing the present action after receiving the instruction, and the mobile device continues performing the present action.

Step S11: optionally, after the present action is transferred back to the mobile device, returning to Step S02, to detect by the mobile device a new fixed device again; or returning to Step S06, to determine again by the mobile device whether to transfer now the present action to a matched fixed device based on the optional information.

After the present action is transferred back to the mobile device, only the mobile device is performing the present action. At this time the mobile device may be very close to a fixed device (which may be a fixed device previously matched with the mobile device, or may be another fixed device), thus subsequent steps can be carried out accordingly to determine whether to transfer the present action to this fixed device.

The transfer process of Steps S09 to S11 may be very fast, thus when a user moves from a vicinity of a fixed device to a vicinity of another fixed device while carrying a mobile device, it is possible that the user completely fails to notice that the present action has been transferred back to the mobile device, only noticing that the present action is transferred from one fixed device to another. It is to be understood, however, this does not mean that the present action can be transferred between fixed devices, and the actual process still is “transferring the present action back to the mobile device, and then transferring again the present action to a fixed device”.

Of course, if no suitable fixed device is discovered for the transfer at the moment, the mobile device may continue performing the present action; or, if the mobile device is discovered to be already disconnected to the wireless network, then the action performing method of this embodiment may be stopped, making no further attempts to transfer an action.

Of course, a number of known variations can be made to the action performing method above. For example, a user can make a private setting in advance, so that the present action will not be transferred when the private setting is on; for another example, before transferring an action, a question window may pop up on the mobile device to wait for the user's confirmation, and the action transfer is performed after the user confirms.

It is to be understood that above implementations are exemplary implementations that are merely employed to illustrate the principle of the present invention, and the present invention is not limited thereto. For an ordinary person skilled in the art, it is possible to make various variations and modifications without departing from the spirit and nature of the present invention, and these variations and modifications are also regarded as within the scope of protection of the present invention.

1. A mobile device, comprising:
an executing unit, for performing an action of displaying an image and/or playing a sound;
a processing unit, for acquiring optional information, determining whether to transfer the action to a fixed device based on the optional information, and transferring the action to the fixed device if the determination result is yes, otherwise not transferring the action, the optional information including a distance between the fixed device and the mobile device; and
a first wireless communication unit, for enabling the mobile device to perform a first information exchange with the fixed device in a wireless manner, the first information exchange includes sending information required for performing the action to the fixed device.

2. The mobile device according to claim 1, wherein the optional information further includes at least one of a type of the action, a property of the fixed device, and a historic record of action transfer.

3. The mobile device according to claim 1, wherein
the processing unit is further used for, after transferring the action to the fixed device, determining whether to transfer the action that has been transferred to the fixed device back to the mobile device based on the distance between the fixed device and the mobile device, and transferring the action that has been transferred to the fixed device back to the mobile device if the determination result is yes, otherwise not transferring the action that has been transferred to the fixed device.

4. The mobile device according to claim 1, wherein
the first information exchange further includes receiving the optional information stored in the fixed device from the fixed device.

5. The mobile device according to claim 1, wherein the first wireless communication unit is a wireless local area network unit.

6. The mobile device according to claim 1, wherein the mobile device is a mobile communication terminal or a tablet PC.

7. An action performing system, comprising:
at least one mobile device according to claim 1;
at least one fixed device capable of performing an action of displaying an image and/or playing a sound, which includes a second wireless communication unit; and
a distance measurement unit, wherein
the second wireless communication unit is used for enabling the fixed device to perform a second information exchange with the mobile device in a wireless manner, the second information exchange includes receiving information from the mobile device required for performing the action; and
the distance measurement unit is used for detecting a distance between the mobile device and the fixed device, and sending the detection result to the processing unit of the mobile device.

8. The action performing system according to claim 7, wherein the optional information further includes at least one of a type of the action, a property of the fixed device, and a historic record of action transfer.

9. The action performing system according to claim 7, wherein
the processing unit is further used for, after transferring the action to the fixed device, determining whether to transfer the action that has been transferred to the fixed device back to the mobile device based on the distance between the fixed device and the mobile device, and transferring the action that has been transferred to the fixed device back to the mobile device if the determination result is yes, otherwise not transferring the action that has been transferred to the fixed device.

10. The action performing system according to claim 7, wherein
the first information exchange further includes receiving the optional information stored in the fixed device from the fixed device.

11. The action performing system according to claim 7, wherein
the at least one fixed device includes a plurality of fixed devices;
the processing unit of the mobile device determines whether to transfer the action to the fixed device based on the optional information, specifically, compares the optional information of the plurality of fixed devices with each other, and determines whether to transfer the action to one of the plurality of fixed devices; if the determination result is yes, transfers the action to the one of the plurality of fixed devices, otherwise does not transfer the action.

12. The action performing system according to claim 8, wherein
the at least one fixed device includes a plurality of fixed devices;
the processing unit of the mobile device determines whether to transfer the action to the fixed device based on the optional information, specifically, compares the optional information of the plurality of fixed devices with each other, and determines whether to transfer the action to one of the plurality of fixed devices; if the determination result is yes, transfers the action to the one of the plurality of fixed devices, otherwise does not transfer the action.

13. The action performing system according to claim 9, wherein
the at least one fixed device includes a plurality of fixed devices;
the processing unit of the mobile device determines whether to transfer the action to the fixed device based on the optional information, specifically, compares the optional information of the plurality of fixed devices with each other, and determines whether to transfer the action to one of the plurality of fixed devices; if the determination result is yes, transfers the action to the one of the plurality of fixed devices, otherwise does not transfer the action.

14. The action performing system according to claim 10, wherein
the at least one fixed device includes a plurality of fixed devices;
the processing unit of the mobile device determines whether to transfer the action to the fixed device based on the optional information, specifically, compares the optional information of the plurality of fixed devices with each other, and determines whether to transfer the action to one of the plurality of fixed devices; if the determination result is yes, transfers the action to the one of the plurality of fixed devices, otherwise does not transfer the action.

15. The action performing system according to claim 7, wherein the second wireless communication unit is a wireless local area network unit.

16. The action performing system according to claim 7, wherein the second information exchange further includes sending the optional information stored in the fixed device to the mobile device.

17. The action performing system according to claim 7, wherein the fixed device includes one or more of a TV, a computer, a monitor, and a speaker.

18. An action performing method, comprising:
performing, by a mobile device, an action of displaying an image and/or playing a sound;
acquiring, by the mobile device, optional information, the optional information including a distance between the fixed device and the mobile device;
determining, by the mobile device, whether to transfer the action to the fixed device based on the optional information; and
if the determination result is yes, then sending, by the mobile device, information required for performing the action to the fixed device in a wireless manner, and performing the action by the fixed device, otherwise not transferring the action.

19. The action performing method according to claim 18, further comprising:
after transferring the action to the fixed device, determining, by the mobile device, whether to transfer the action that has been transferred to the fixed device back to the mobile device based on the distance between the fixed device and the mobile device; if the determination result is yes, then stopping performing the action by the fixed device, and continuing to perform the action by the mobile device, otherwise not transferring the action that has been transferred to the fixed device.
